(19) United States
(12) Patent Application Publication
(10) Pub. No.: US 2017/0052736 A1
(43) Pub. Date: Feb. 23, 2017

(54) READ AHEAD BUFFER PROCESSING

(71) Applicant: HEWLETT PACKARD ENTERPRISE DEVELOPMENT LP, Houston, TX (US)

(72) Inventors: John BUTT, Bristol (GB); Peter Thomas CAMBLE, Bristol (GB); Alastair SLATER, Bristol (GB)

(73) Assignee: HEWLETT PACKARD ENTERPRISE DEVELOPMENT LP, Houston, TX (US)

(21) Appl. No.: 15/307,469

(22) PCT Filed: May 23, 2014
(86) PCT No.: PCT/US2014/039312

§ 371 Date: Oct. 28, 2016

(51) Int. Cl. G06F 3/06; G06F 17/30; G06F 11/14

(52) U.S. Cl. CPC G06F 3/0656; G06F 11/1451; G06F 3/0613; G06F 3/0619; G06F 3/064; G06F 3/0643; G06F 3/067; G06F 17/30082; G06F 17/30194; G06F 2201/80; G06F 2201/805; G06F 2201/82

(57) ABSTRACT

Read data blocks based on a read-amount multiplied by an increment-amount from data storage and write the data blocks to the read-ahead buffer. If the total number of data blocks written to the read-ahead buffer is greater than or equal to the request-amount, then returning to the host the total number of data blocks written to the read-ahead buffer. If the total the number of data blocks written to the read-ahead buffer is less than the request-amount, repeating incrementing the increment-amount and reading data blocks equal to the read-amount multiplied by the increment-amount from the data storage, and writing the read data blocks to the read-ahead buffer until the total number of data blocks written to the read-ahead buffer is greater than or equal to the request-amount.

### BACKGROUND

Computer systems may include host computers coupled to storage systems to backup and restore file systems. A file system may include data blocks which are groups of data comprised of bytes of data organized as files as part of directory structures. A host may send to the storage system write commands to write data blocks from the host to data storage to back up the file system for possible future restore of the file system. Further, a host may send to the storage system read commands to read data blocks back from storage and return the data blocks to the host to restore portions the file system that have encountered errors or data loss.

### BRIEF DESCRIPTION OF THE DRAWINGS

FIG. 1 is a block diagram of a computer system for read-ahead processing according to an example implementation.

FIG. 2 is a flow diagram of a computer system for read-ahead processing of FIG. 1 according to an example implementation.

FIG. 3 is a flow diagram of a computer system for read-ahead processing according to another example implementation.

FIG. 4 is a block diagram of operation of a computer system for read-ahead processing according to another example implementation.

FIG. 5 is an example block diagram showing a non-transitory, computer-readable medium that stores instructions for a computer system for read-ahead processing in accordance with an example implementation.

### DETAILED DESCRIPTION

Computer systems may include host computers coupled to storage systems to backup and restore file systems. A file system may include data blocks which are groups of data comprised of bytes of data organized as files as part of directory structures. A host may include a host application to backup and restore a file system in case portions of the file system encounter data loss. The host may send to the storage system write commands to write data blocks from the host to data storage to back up the file system for possible future restore of the file system. Further, a host may send to the storage system read commands to read data blocks back from storage and return the data blocks to the host to restore the file system. The storage system may include write buffers which are data structures to store data blocks from the hosts which are then written to storage in response to the write commands. In addition, the storage system may have read buffers to store data blocks read from the data storage and then returned to the hosts in response to the read commands.

However, read commands which may cause the storage system to “read ahead” a particular number of data blocks associated with the file system. For example, a read command may cause the storage system to read a large number of data blocks such as 40 Megabytes (MB) of data and write the data to the read buffer. In the meantime, while the storage system is reading data blocks and writing the data blocks to the read buffer, the host may be waiting for the storage system to complete the read command by filling the read buffer with 40 MB of data. As a result of the read latency, the host may experience a decrease in performance which may be undesirable.

In one example, the host may be coupled to a storage system that may include a storage module with functionality to perform deduplication on data received from the host and then store the deduplicated data to data storage for backup purposes. In this context, data deduplication functionality may include any data compression technique to eliminate duplicate copies of repeating data. The storage module may include a read module and a write module configured to operate as respective streaming reading and writing devices. The host may include a backup and restore application. As part of the backup operation, the host may send requests to the write module to deduplicate the data associated with the host file system and then write the deduplicated data to data storage. As part of the restore operation, the host may send requests to the read module to retrieve deduplicated data items which may involve several data blocks associated with the file system. In this case, the read request may include location information followed by large number (at least multiple MB) of sequential read commands sent to the data storage system. In order to allow for more efficient restore application reading, the read module may read ahead data by a particular number of data blocks associated with the file system and then write or populate the read buffer which may be used to satisfy host application read requests.

However, host backup and restore applications may cause the read module to perform a large number of non-sequential small read requests in the kilobyte (kB) range. In this case, it may be inefficient for the read module to “read ahead” too much data associated with the file system as the majority of data may not be required or necessary to satisfy the host application read request. The read module may not be aware of the characteristics of the read request such as the number and size of future host application read requests. Therefore, it may be desirable to provide techniques to perform minimal read ahead operations associated with a file system as possible to satisfy host application read requests.

In some examples of the present application, techniques are disclosed which may improve read buffer functionality and increase overall performance. For example, some hosts may manage a file system and be coupled to a data storage system to backup and restore the file system. However, file system retrieval for restoration of the file system from the data storage system and back to the host may be expensive or demanding in terms of performance. It therefore may be desirable to limit the amount of data read from storage to a minimum amount required to satisfy application read requests. However, it may be desirable for file system retrieval to read ahead from the data storage, where possible, to help reduce the latency of future host application read requests. The present application may provide for techniques to help reduce read latency and file system retrieval to the minimum required to satisfy host application read requests.

In one example, disclosed is a storage apparatus that includes a read-ahead module to read data blocks based on a read-amount multiplied by an increment-amount from data storage and write the data blocks to the read-ahead buffer. The read-amount represents the amount of data that read-ahead module is to read from data storage and mite to read-ahead buffer. For example, the read-amount may be 64 kB which may represent one data block whereas the size of the read-ahead buffer may be 40 MB which may represent multiple data blocks. The increment-amount is a variable that behaves as a loop counter and is initially set to a value of 1 and is incremented by 1 each time the process reads a data block.

The read-ahead module may be configured to check whether a number of data blocks written to the read-ahead buffer is greater than or equal to a request-amount received from a host. For example, the request-amount may be set to a value of 128 kB (which may represent two data blocks) while the read-amount may be set to a value of 64 kB (which may represent one data block). If the total number of data blocks written to the read-ahead buffer is greater than or equal to the request-amount (128 kB which may represent two data blocks of data), then the system returns to the host the total number of data blocks written to the read-ahead buffer. On the other hand, if the total the number of data blocks written to the read-ahead buffer is less than the request-amount then the system repeats incrementing the increment-amount and reads data blocks equal to the read-amount (64 kB which may represent one data block of data) multiplied by the increment-amount from the data storage. It then writes the read data blocks to the read-ahead buffer until the total number of data blocks written to the read-ahead greater than or equal to the request-amount (128 kB which may represent two data blocks of data).

In another example, disclosed is a read-ahead module coupled to read-ahead buffer and configured to help reduce read latency and the system retrieval to a minimum required to satisfy application read requests. The read-ahead module may comprise functionality such as a read-data process and a read-ahead process which may be configured to operate or execute in an asynchronous manner with respect to each other. That is, the read-ahead process may execute as a separate process from the read-data process and may be able to communicate with each other, such as share data and status, as they perform their respective functions during execution.

In one example, a host application may be a backup and restore application. As part of restore function, the host may send a read command to the read-ahead module which may cause the read-ahead process to execute and initiate the asynchronous read-ahead process. The read-ahead process may begin to read ahead data from data storage, such as disk drive storage, and populate the read-ahead buffer that is likely to be required by the host. Initially, only a small amount of data (read-amount) is read from data storage (such as 64 kB which may represent one data block of data) because disk drive input/output (I/O) may be expensive in terms of performance. At some point after the host begins execution of the read-ahead process, the host may send a read-data command to the read-ahead module which causes the read-ahead module to execute a read-data process which requests that a particular number (request-amount such as 128 kB which may represent two data blocks of data) of data blocks or bytes be returned back to the host by the read-ahead process. The host may wait for the read-ahead process to fill or populate the read-ahead buffer with enough data to fully satisfy the read request.

In this manner, these techniques may help reduce host application and file system read latency and data retrieval from data storage to a minimum required to satisfy host application read requests.

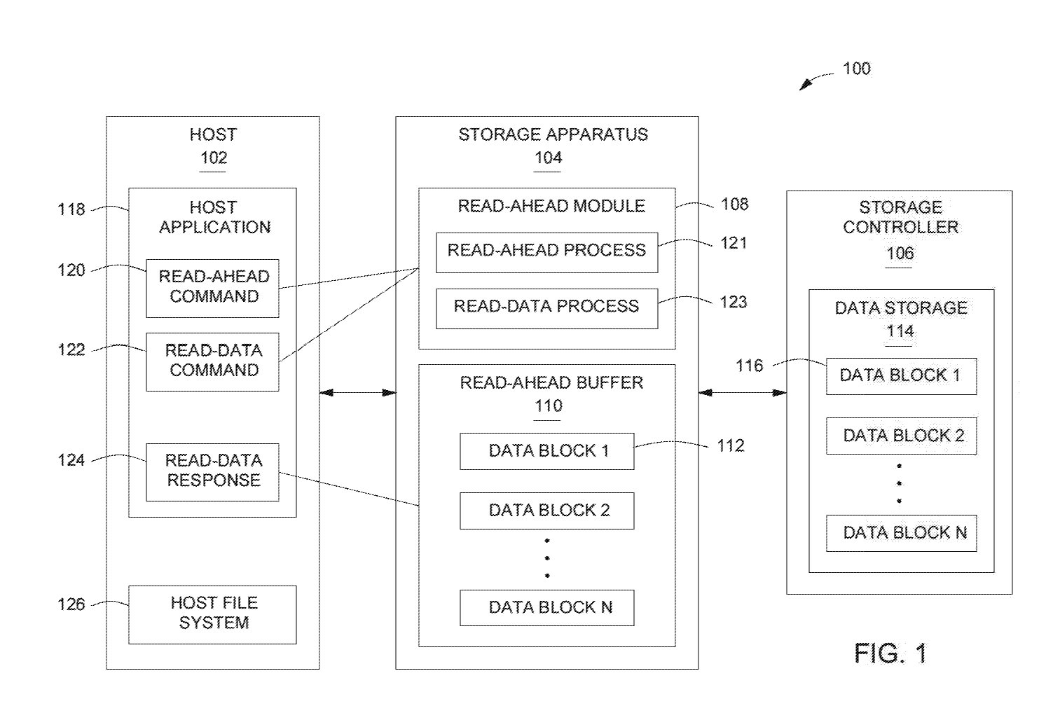

FIG. 1 is a block diagram of a computer system 100 for read-ahead processing according to an example implementation. The computer system 100 includes a storage apparatus 104 coupled between a host 102 and a storage controller 106 where the storage apparatus includes a read-ahead module 108 for managing host requests for accessing data storage 114.

The host 102 may be any electronic device capable of data processing such as a server computer, mobile device and the like. The host 102 includes a host application 118 for managing the operation of the host including communication with storage apparatus 104. In one example, host application 118 may include functionality for management of host file system 126. The file system 126 may be any electronic means of management of storage and retrieval of data. In one example, file system 126 may store data that may be organized into individual portions and each portion is assigned a name that may be easily separated and identified. In one example, file system 126 may be organized where the portions of data are called files and where the files are organized in a directory or tree structure.

The host application 118 may include functionality to communicate with storage apparatus 104. For example, host application 118 may be a backup and restore application which may request that storage apparatus 104 perform functions to backup and restore data blocks of file system 126.

As part of a backup operation, host application 118 may send to storage apparatus 104 commands or requests (not shown) to backup specified data blocks of file system 126. The commands may include data blocks of file system 126 which storage apparatus 104 which will then write as data blocks 116 at data storage 114.

As a first part of a restore operation, host application 118 may send to storage apparatus 104 read-ahead commands 120 to cause storage apparatus to initiate retrieval of read-amount size of data blocks 116 from storage 114 associated with file system 126. For example, host application 118 may set the read-amount size to a value or amount 64 kB which may represent one data block of data. As explained below, storage apparatus 104 may respond to the read-ahead command 120 by initiating a read-ahead process 121 and a read-data process 123. As a second or subsequent part to the restore operation, at some point in time after the read-ahead command is sent, host application 118 may send to storage apparatus 104 a read-data command 122 to request that storage apparatus retrieve or return a request-amount of data blocks 112 associated with file system 126. In one example, the request-amount may be multiples of read-amount. In one example, read-amount may be 64 kB (which may represent one data block of data) and request-amount may be 128 kB (which may represent two data blocks of data). In this case, request-amount may be a multiple of read-amount. As explained below in further detail, storage apparatus 104 may respond by executing read-data process 123 and checking whether read-ahead process 121 retrieved the request-amount. In one example, when read-ahead process 121 has retrieved the request-amount, storage apparatus 104 may respond with a read-data response 124 along with the request-amount worth of data blocks. On the other hand, if read-ahead process 121 is still in the process of retrieving the request-amount, storage apparatus 104 may respond to host with a message indicating the retrieval process is still in progress.

It should be understood that the description of host 102 above is for illustrative purposes and other implementations of the host may be employed to practice the techniques of the present application. For example, host 102 is shown as a single component but host 102 may include a plurality of hosts coupled to storage apparatus 104.

The storage apparatus 104 may be any electronic device capable of data processing such as a server computer, mobile device and the like. The storage apparatus 104 includes functionality to communicate with host 102 and storage controller 106. The storage apparatus 104 may communicate with host 102 and storage controller 106 using any electronic communication means including wired, wireless, network based such as storage area network (SAN), Ethernet, Fibre Channel and the like. The storage apparatus 104 includes a read-ahead module 108 to manage read-ahead buffer 110 to store and retrieve data blocks 112. The size of read-ahead buffer 110 may be any size. In some examples, the size of read-ahead buffer may be a multiple of data blocks 112. In one example, the size of each data block may be 64 kB (which may represent one data block of data) and the size of the read-ahead buffer 110 may be 40 MB which is a multiple of 64 kB which may represent multiple data blocks of data. In some examples, read-ahead module 108 may store data blocks 116 from data storage 114 as data blocks 112 in read-ahead buffer 110 as a result of a restore function or operation. The storage apparatus 104 may receive from host 102 restore commands to return data blocks 116 of file system 126 from data storage 114. In a similar manner, storage apparatus 104 may receive from host 102 backup commands to backup or copy data blocks of file system 126 as data blocks 116 to data storage 114.

The read-ahead buffer 110 may be any non-transitory, computer-readable medium corresponding to storage device that stores computer readable data. For example, read-ahead buffer 110 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

As explained above, storage apparatus 104 may be configured to perform backup and restore functions on file system 126 of host 102. In one example, storage apparatus 104 may receive commands or requests (not shown) to backup specified data blocks of file system 126 which may include receiving data associated with file system 126 which will then be written to data storage 114. The read-ahead module 108 includes a read-ahead process 121 and a read-data process 123 for management of restore operations. In one example, as a first part of a restore operation, storage apparatus 104 may receive read-ahead commands 120 to cause read-ahead module 108 to initiate retrieval of read-amount size of data blocks 112 associated with file system 126.

In one example, read-ahead module 108 may respond by initiating execution of read-ahead process 121 and read-data process 123. As a second or subsequent part to the restore operation, at some point in time after the read-ahead command, read-ahead module 108 may receive from host 102 a read-data command 122 to cause the read-ahead module to begin retrieval of a request-amount data blocks 112 associated with file system 126. The read-ahead module 108 may respond by executing read-data process 123 and checking whether the read-ahead process 121 retrieved the request-amount. In one example, when read-ahead process 121 has retrieved the request-amount, read-ahead module 108 may respond to host 102 with a read-data response 124 along with the request-amount worth of data blocks. On the other hand, if read-ahead process 121 is still in the process of retrieving the request-amount, storage apparatus 104 may respond to host with a message indicating the retrieval process is still in progress.

The storage controller 106 may be any electronic device capable of data processing such as a server computer, mobile device and the like. The storage controller 106 includes functionality to manage communications with storage apparatus 104. The functionality may include computer implemented modules configured for processing commands from storage apparatus 104 to read specified data blocks 116 from data storage 114. The data storage 114 may be any means to store data as data blocks 116 and to retrieve the data blocks. The data blocks 116 may be any group or multiple of bytes of data such as 64 kB size. Similar to read-ahead buffer 110, data storage 114 may be any non-transitory computer-readable medium corresponding to storage device that stores computer readable data.

To illustrate operation, in one example, read-ahead module 108 may be configured to help reduce file system retrieval to a minimum required to satisfy application read requests. The read-ahead process 121 and read-data process 123 which may operate or execute in an asynchronous manner with respect to each other. That is, read-ahead process 121 may execute as a separate process or thread from read-data process 123 but may be able to communicate with each other as they perform their functions during execution. In one example, host application 118 may send a read-ahead command 120 to read-ahead module 108 which may cause read-ahead process 121 to execute and initiate an asynchronous read ahead process. The read-ahead process 121 may include beginning to read ahead data from data storage 114, such as disk drive storage, and populate read-ahead buffer 110 with data blocks that is likely to be required by the host. Initially, only a small amount of data (read-amount) is read from data storage (such as 64 kB) as disk drive input/output (I/O) may be expensive in terms in performance.

Continuing with the operation, at some point after host 102 begins execution of read-ahead process 121, the host sends a read-data command 122 to read-ahead module 108 which causes the read-ahead module to execute read-data process 123 specify a particular number (request-amount) of data blocks or bytes to be returned by the read-ahead process. The host 102 may wait for the read-ahead process to fill or populate the read-ahead buffer 110 with enough data to fully satisfy the read request. When read-ahead process 121 has retrieved the request-amount, read-ahead module 108 may respond to host 102 with a read-data response 124 along with the request-amount worth of data blocks. Otherwise, if read-ahead process 121 is still in the process of retrieving the request-amount, read-ahead module 108 may respond to host 102 with a message indicating the retrieval process is still in progress.

In this manner, these techniques may help reduce host application 118 and file system 126 data retrieval from data storage 114 to a minimum required to satisfy host application read requests

The functionality of the components of system 100 including host 102, storage apparatus 104 and storage controller 106 may be implemented in hardware, software or a combination thereof. It should be understood that the description of system 100 is for illustrative purposes and other implementations of the system may be employed to practice the techniques of the present application. For example system 100 is shown as having a storage apparatus 104 coupled between host 102 and storage controller 106. However, system 100 may have a plurality of storage apparatus 104 coupled between a plurality of hosts 102 and plurality of storage controllers 106.

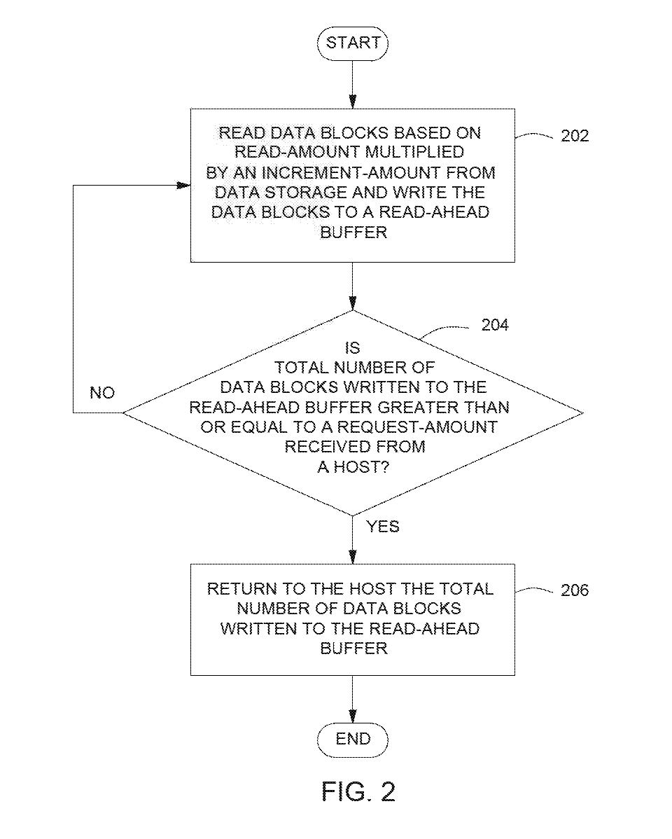

FIG. 2 is a flow diagram of a computer system for read-ahead processing of FIG. 1 according to an example implementation. In one example, to illustrate operation, it may be assumed that read-amount is set to a value of 64 kB (which may represent one data block of data), request-amount is set to a value of 128 kB (which may represent two data blocks of data), read-buffer size is set to a value of 40 MB (which may represent multiple data blocks of data), and increment-amount is set to a value of 1. It may also be assumed that host 102 previously sent backup commands to storage apparatus to have file system 126 stored to data storage 114 for subsequent restore purpose. In this example, it may be further assumed that host 102 may have experienced a data loss of at least a portion of file system 126 and that it desires to restore these portions of the file system.

At block 202, storage apparatus 104 reads data blocks 116 based on read-amount multiplied by increment-amount from data storage 114 and writes the data blocks to read-ahead buffer 110. As explained above, it is assumed that host 102 may have experienced a data loss of at least a portion of file system and that it desires to restore these portions of the file system. In this case, host application 118 sends a read-ahead command 120 to read-ahead module 108 which initiates execution of read-ahead process 121 and initiates asynchronous execution of read-data process 123. The read-ahead process 121 may begin to read ahead data from data storage 114 and populate read-ahead buffer 110. The read-ahead command 120 may include location information of the location of deduplicated data blocks associated with the relevant portions of file system 126 to be read from data storage 114 and written to read-ahead buffer 110. Processing proceeds to block 204.

At block 204, storage apparatus 104 checks whether the total number of data blocks written to read-ahead buffer 110 is greater than or equal to request-amount received from host 102. As explained above, to illustrate operation, it was assumed that read-amount was set to a value of 64 kB (which may represent one data block of data), increment-amount was set to a value of 1, request-amount was set to a value of 128 kB (which may represent one data block of data), and read-buffer size 40 MB. In this case, if the total number of data blocks written to read-ahead buffer 110 is greater than or equal to request amount (128 kB which may represent two data blocks of data), then processing proceeds to block 206. In other words, if read-ahead module 108 wrote request-amount (128 kB) worth of data to read-ahead buffer, then the host read request is satisfied and processing proceeds to block 206.

Continuing with the above example, on the other hand, if the total number of data blocks written to the read-ahead buffer is not greater than or equal to request-amount (128 kB), then processing proceed back to block 202. In other words, read-ahead module 108 processing proceeds back to block 202 where the module increments increment-amount by a value of 1 and continues to read read-amount (64 kB which may represent one data block of data) amounts of data blocks until the request-amount (128 kB which may represent two data blocks of data) worth of data is written to read-ahead buffer 110.

At block 206, storage apparatus 104 returns to the host the total number of data blocks written to the read-ahead buffer. In this case, continuing with the above example, read-ahead module 108 wrote request-amount (128 kB which may represent two data blocks of data) worth of data to read-ahead buffer 110 and the read-ahead module may send a read-data response 124 along with the request-amount worth of data (128 kB) back to host 102. The host 102 may then use the returned data to restore portions of file system 126 that experienced data loss or corruption. Once processing at block 206 is complete, storage apparatus 104 processing may proceed back to block 202 to wait or monitor for another read-ahead command 120 from host 102.

In this manner, these techniques may help reduce host application 118 and file system 126 data retrieval from data storage 114 to a minimum required to satisfy host application read requests.

It should be understood that the above process 200 is for illustrative purposes and that other implementations may be employed to the practice the techniques of the present application. For example, at block 204, other comparisons may be employed such as comparing the total number of blocks written to the buffer exceeds against a particular threshold other than request-amount.

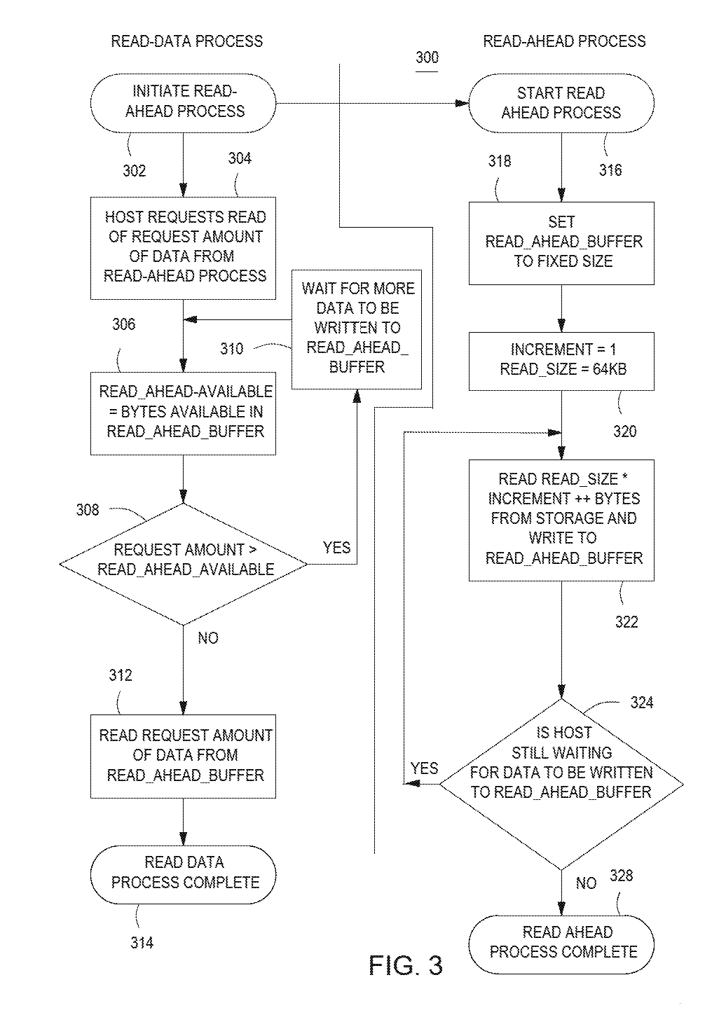

FIG. 3 is a flow diagram 300 of a computer system for read-ahead processing according to another example implementation.

In one example, to provide an overview of overall operation, it may be assumed that read-ahead module 108 is configured to help reduce file system retrieval to a minimum required to satisfy application read requests. As explained above, read-ahead process 121 and a read-data process 123 may operate or execute in an asynchronous manner with respect to each other. That is, read-ahead process 121 may execute as a separate process from read-data process 123 and may be able to communicate with each other as they perform their individual functions during execution. The host application 118 may send a read-ahead command 120 to read-ahead module 108 to cause read-ahead process 121 to execute and initiate asynchronous execution of the read-ahead process.

Continuing with the above example, read-ahead process 121 may begin to read ahead data from data storage 114, such as disk drive storage, and populate read-ahead buffer 110 that is likely to be required by the host. Initially, only a small amount of data (read-amount) is read from data storage (such as 64 kB) as disk drive input/output (I/O) may be expensive in terms in performance. At some point after host 102 initiates read-ahead process 121, the host sends a read-data command 122 to read-ahead module 108 which causes the module to execute read-data process 123 which specifies a particular number (request-amount) of data blocks or bytes to be returned by the read-ahead process. In this case, to illustrate, it may be assumed that request-amount is 128 kB and read-amount is 64 kB.

The read-data process 123 involves block 302 through block 314 while the read-ahead process 121 involves block 316 through block 328.

Turning to the execution of read-data process 123, at block 302, storage apparatus 104 initiates read-ahead process 302. In one example, host application 118 sends a read-ahead command 120 to read-ahead module 108 to cause read-ahead process 121 to execute and initiate asynchronous execution of the read-ahead process starting at block 316 below. In addition, read-ahead module 108 may begin execution of read-data process 123 starting at block 304.

At block 304, storage apparatus 104 receives from host 102 a request to read a request-amount of data from read-ahead process at block 316. In one example, at some point after host 102 initiated read-ahead process 121 above, host 102 sends a read-data command 122 to read-ahead module 108 which causes the read-ahead module to execute read-data process 123. The read-data command 122 may specify a particular number (request-amount) of data blocks or bytes to be returned by the read-ahead process. In this case, to illustrate, it may be assumed that request-amount is 128 kB (which may represent two data blocks of data) and read-amount is 64 Kb (which may represent one data block of data). Processing then proceeds to block 306

At block 306, storage apparatus 104 calculates a read-ahead-available variable to determine the amount of data available in read-ahead buffer 110. As explained above, read-ahead process 121 is reading ahead data from data storage 114 and populating read-ahead buffer 110 with data blocks 116 in read-amounts 64 kB that is likely to be required by the host. Initially, only a small amount of data (read-amount) is read from data storage (such as 64 kB). Processing then proceeds to block 308

At block 308, storage apparatus 104 checks whether request-amount is greater than the read-ahead-available amount. In one example, read-ahead process 121 is filling or populating read-ahead buffer 110 with enough data to fully satisfy the read request-amount of 128 kB. If the request-amount is greater than the read-ahead-available amount, then processing proceeds to block 310. On the other hand, if the request-amount is not greater than the read-ahead-available amount, then processing proceeds to block 312.

At block 310, storage apparatus 104 waits for more data to be written to read-ahead buffer 110. In one example, storage apparatus 104 may send a response to host 102 indicating that the request-amount (128 kB which may represent two data blocks of data) of data has not yet been written to read-ahead buffer. In other words, host 102 may need to wait for the read-ahead process 121 to fill or populate read-ahead buffer 110 with enough data to fully satisfy the request-amount of 128 kB. Processing then proceeds to block 306 where read-data process 123 continues to check whether read-ahead process 121 has completed or satisfied the host request-amount.

At block 312, storage apparatus 104 reads request-amount of data from read-ahead buffer 110. In one example, read-ahead process 121 has completed or satisfied the host request-amount of 128 kB which may represent two data blocks of data. In this case, read-ahead process 121 has written request-amount (128 kB) worth of data to read-ahead buffer 110 and read-ahead module 108 may send a read-data response 124 along with the request-amount worth of data (128 kB) back to host 102. The host 102 may then use the returned data to restore portions of file system 126 that experienced data loss or corruption. Processing then proceeds to block 314.

At block 314, storage apparatus 104 completes the read-data process 123. As explained above, the total number of data blocks written to read-ahead buffer 110 was greater than or equal to the request-amount. In one example, read-ahead module 108 may halt further reading of data blocks 116 from data storage 114 and halt further writing of data blocks to the read-ahead buffer.

Turning to the read-data process, at block 316, storage apparatus 104 starts the read-ahead process 121. In one example, host application 118 sends a read-ahead command 120 to read-ahead module 108 to cause read-ahead process 121 to execute and initiate asynchronous execution of the read-ahead process. Processing then proceeds to block 318 below.

At block 318, storage apparatus 104 sets the read-ahead buffer size of read-ahead buffer 110 to a fixed size. In one example, read-ahead buffer size may be set to a value of 40 MB. For example, the size of read-ahead buffer 110 may be set to a value by host application 118 based on the requirements of file system 126. Processing then proceeds to block 320 below.

At block 320, storage apparatus 104 sets the increment-amount variable to a value of 1 and the read-amount variable to a value of 64 kB. In one example, the read-amount may be set to a value by host application 118 based on the requirements of file system 126. For example, the read-amount may be 64 kB (which may represent one data block of data) whereas the size of the read-ahead buffer may be 40 MB. The increment-amount is a variable that behaves as a loop counter and is initially set to value of 1 and is incremented by 1 each time the process is performed. Processing then proceeds to block 322 below

At block 322, storage apparatus 104 reads data blocks from data storage 114 in the amount of read-amount multiplied by increment amount and writes the read data blocks to read-ahead buffer 110. In this example, read-ahead module 108 reads 64 kB worth of data (read-amount) multiplied by 1 (increment-amount) from data storage 114 and mites that data as data blocks 112 to read-ahead buffer 110. Processing then proceeds to block 324 below.

At block 324, storage apparatus 104 checks whether host 102 is still waiting for data to be written to read-ahead buffer 110. In this case, if read-ahead module 108 has written request-amount (128 kB which may represent two data blocks of data) worth of data blocks to read-ahead buffer 110, then host 102 would be satisfied and proceeding may proceed to block 328. On the other hand, if read-ahead module 108 has not written request-amount (128 kB) worth of data blocks to read-ahead buffer 110, than host 102 would not be satisfied and proceeding proceeds back block 322.

At block 328, storage apparatus 104 completes the read-ahead process 121. In one example, read-ahead module 108 may notify read-data process 123 that it has written request-amount (128 kB) worth of data blocks to read-ahead buffer 110 thereby satisfying host application 118 read request. In one example, read-ahead module 108 may then halt further reading data blocks 116 from data storage 114 and halt further writing the data blocks to the read-ahead buffer 110.

In this manner, these techniques may help reduce host application 118 and file system 126 data retrieval from data storage 114 to a minimum required to satisfy host application read requests.

It should be understood that the above process 300 is for illustrative purposes and that other implementations may be employed to the practice the techniques of the present application. For example, at block 320, other request-amount values may be employed such as request-amount of three data blocks of data.

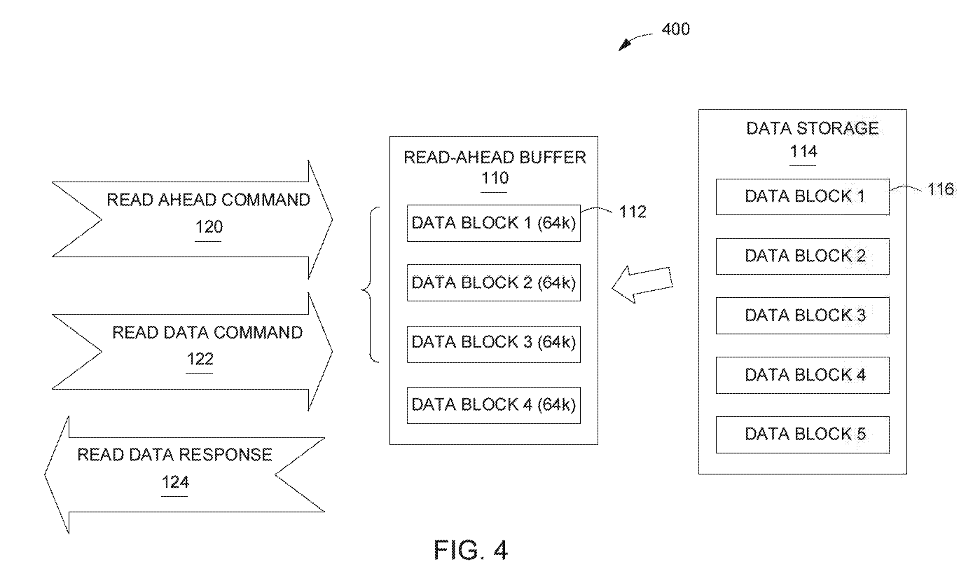

FIG. 4 is a block diagram 400 of operation of a computer system for read-ahead processing according to another example implementation.

In one example, to illustrate operation, to provide an overview of overall operation, it may be assumed that read-ahead module 108 is configured to help reduce file system retrieval to a minimum required to satisfy application read requests. The read-ahead process 121 and a read-data process 123 may operate or execute in an asynchronous manner with respect to each other. That is, read-ahead process 121 may execute as a separate process from read-data process 123 and may be able to communicate with each other as they perform their individual functions during execution. In one example, to illustrate, it may be assumed that read-amount is 64 kB (which may represent one data block of data) and the request-amount is three data blocks of data and. In other words, the request-amount is a total of three data-blocks 116 from data storage 114 to be written as data blocks 112 to read-ahead buffer 110 (Data Block 1, Data Block 2 and Data Block 3).

At an initial step, host application 118 may send a read-ahead command 120 to read-ahead module 108 to cause read-ahead process 121 to execute and initiate asynchronous execution of the read-ahead process. The read-ahead process 121 may begin to read ahead data from data storage 114 and populate read-ahead buffer 110 that is likely to be required by the host. A small amount of data (read-amount) is read from data storage (such as 64 kB).

At some point after host 102 initiates read-ahead process 121, host 102 sends a read-data command 122 to read-ahead module 108 which causes the module to execute read-data process 123 which specifies a particular number (request-amount) of data blocks or bytes to be returned by the read-ahead process. In this case, to illustrate, it may be assumed that the read-amount is 64 kB and request-amount is three data blocks. The host 102 may wait for the read-ahead process 121 to fill or populate read-ahead buffer 110 with enough data to fully satisfy the read request-amount of three data blocks. In this case, as explained above, the request-amount represents a total of three data-blocks 116 from data storage 114 to be written as data blocks 112 to read-ahead buffer 110 (Data Block 1, Data Block 2 and Data Block 3).

In one case, when storage apparatus 104 receives the read-data command 122, the storage apparatus may have filled the read-ahead buffer 110 with three data blocks worth of data. In this case, storage apparatus 104 responds to host 102 with a read-data response 124 containing the three data blocks of data from read-ahead buffer 110.

On the other hand, at the time storage apparatus 104 receives the read-data command 122, the storage apparatus may not have filled the read-ahead buffer 110 with the three data blocks worth of data. In this case, storage apparatus 104 continues to fill read-ahead buffer 110 with 64 kB worth of data. The storage apparatus 104 may send a response to host 102 to continue to wait until the storage apparatus fills the read-ahead buffer 110 with three data blocks worth of data.

In this manner, these techniques may help reduce host application 118 and file system 126 data retrieval from data storage 114 to a minimum required to satisfy host application read requests.

It should be understood that the above process 400 is for illustrative purposes and that other implementations may be employed to the practice the techniques of the present application. For example, the request-amount may be an amount other than three data blocks.

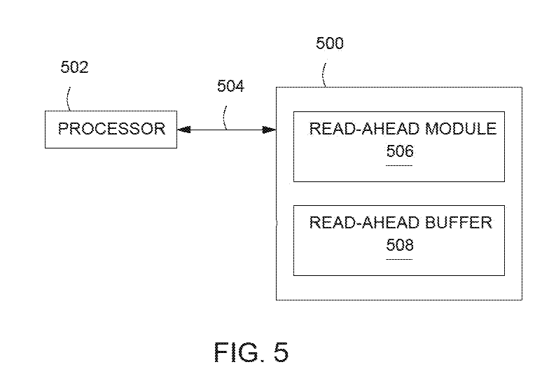

FIG. 5 is an example block diagram showing a non-transitory, computer-readable medium that stores instructions for a computer system for read-ahead processing in accordance with an example implementation. The non-transitory, computer-readable medium is generally referred to by the reference number 500 and may be included in devices of system 100 as described herein. The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

A processor 502 generally retrieves and executes the instructions stored in the non-transitory, computer-readable medium 500 to operate the devices of system 100 in accordance with an example. In an example, the tangible, machine-readable medium 500 may be accessed by the processor 502 over a bus 504. A first region 506 of the non-transitory, computer-readable medium 300 may include read-ahead module functionality as described herein. A second region 508 of the non-transitory, computer-readable medium 500 may include read-ahead buffer functionality as described herein.

Although shown as contiguous blocks, the software components may be stored in any order or configuration. For example, if the non-transitory, computer-readable medium 500 is a hard drive, the software components may be stored in non-contiguous, or even overlapping, sectors.

What is claimed is:

1. A method comprising:
reading data blocks based on a read-amount multiplied by an increment-amount from data storage and writing the data blocks to read-ahead buffer;
checking whether a total number of data blocks written to the read-ahead buffer is greater than or equal to a request-amount received from a host;
if the total number of data blocks written to the read-ahead buffer is greater than or equal to the request-amount, then returning to the host the total number of data blocks written to the read-ahead buffer; and
if the total the number of data blocks written to the read-ahead buffer is less than the request-amount, repeating incrementing the increment-amount and reading data blocks equal to the read-amount multiplied by the increment-amount from the data storage, and writing the read data blocks to the read-ahead buffer until the total number of data blocks written to the read-ahead buffer is greater than or equal to the request-amount.

2. The method of claim 1, further comprising receiving a request from the host that includes a read-ahead command to initiating a read-ahead process that includes reading data blocks based on read-amount multiplied by the increment-amount from the data storage and writing the data blocks to the read-ahead buffer.

3. The method of claim 1, further comprising receiving a request from the host that includes a read-ahead command that includes location information of the location of deduplicated data blocks associated with a file system to be read from data storage and written to the read-ahead buffer.

4. The method of claim 1, further comprising receiving a request from the host that includes a read-data command that initiates a read-data process that includes checking whether the amount of data in the read-ahead buffer is equal to the request-amount and returning the request-amount to the host otherwise responding to the host that the data in the read-ahead buffer is not equal to the request-amount.

5. The method of claim 1, further comprising, checking if the total number of data blocks written to the read-ahead buffer is greater than or equal to the request-amount, then halting further reading data blocks from the data storage and halting further writing of the data blocks to the read-ahead buffer.

6. An apparatus comprising:
a read-ahead buffer to store data blocks from data storage; and
a read-ahead module to:
read data blocks based on a read-amount multiplied by an increment-amount from the data storage and write the data blocks to the read-ahead buffer,
check whether a total number of data blocks written to the read-ahead buffer is greater than or equal to a request-amount received from a host,
if the total number of data blocks written to the read-ahead buffer is greater than or equal to the request-amount, then returning to the host the total number of data blocks written to the read-ahead buffer, and
if the total the number of data blocks written to the read-ahead buffer is less than the request-amount, repeating incrementing the increment-amount and reading data blocks equal to the read-amount multiplied by the increment-amount from the data storage, and writing the read data blocks to the read-ahead buffer until the total number of data blocks written to the read-ahead buffer is greater than or equal to the request-amount.

7. The apparatus of claim 6, wherein the read-ahead module is to receive a request from the host that includes a read-ahead command that initiates a read-ahead process that includes to read data blocks based on read-amount multiplied by the increment-amount from the data storage and write the data blocks to the read-ahead buffer.

8. The apparatus of claim 6, wherein the read-ahead module is to receive a request from the host that includes a read-ahead command that includes location information of the location of deduplicated data blocks associated with a file system to be read from data storage and written to the read-ahead buffer.

9. The apparatus of claim 6, wherein the read-ahead module is to receive a request from the host that includes a read-data command that initiates a read-data process that includes to check whether the amount of data in the read-ahead buffer is equal to the request-amount and to return the request-amount to the host otherwise to respond to the host that the data in the read-ahead buffer is not equal to the request-amount.

10. The apparatus of claim 6, wherein the read-ahead module is to check if the total number of data blocks written to the read-ahead buffer is greater than or equal to the request-amount, then to halt further reading data blocks from data storage and to halt further writing the data blocks to the read-ahead buffer.

11. An article comprising a non-transitory computer readable storage medium to store instructions that when executed by a computer to cause the computer to:
read data blocks based on a read-amount multiplied by an increment-amount from data storage and writing the data blocks to a read-ahead buffer;
check whether a total number of data blocks written to the read-ahead buffer is greater than or equal to a request-amount received from a host;
if the total number of data blocks written to the read-ahead buffer is greater than or equal to the request-amount, then returning to the host the total number of data blocks written to the read-ahead buffer; and
if the total the number of data blocks written to the read-ahead buffer is less than the request-amount, repeating incrementing the increment-amount and reading data blocks equal to the read-amount multiplied by the increment-amount from the data storage, and writing the read data blocks to the read-ahead buffer until the total number of data blocks written to the read-ahead buffer is greater than or equal to the request-amount.

12. The article of claim 11, further comprising instructions that if executed cause a computer to receive a request from the host that includes a read-ahead command that initiates a read-ahead process that includes to read data blocks based on read-amount multiplied by the increment-amount from the data storage and write the data blocks to the read-ahead buffer.

13. The article of claim 11, further comprising instructions that if executed cause a computer to receive a request from the host that includes a read-ahead command that includes location information of the location of deduplicated data blocks associated with a file system to be read from data storage and written to the read-ahead buffer.

14. The article of claim 11, further comprising instructions that if executed cause a computer to receive a request from the host that includes a read-data command that initiates a read-data process that includes to check whether the amount of data in the read-ahead buffer is equal to the request-amount and to return the request-amount to the host otherwise to respond to the host that the amount of data in the read-ahead buffer is not equal to the request-amount.

15. The article of claim 11, further comprising instructions that if executed cause a computer to check if the total number of data blocks written to the read-ahead buffer is greater than or equal to the request-amount, then to halt further reading of data blocks from data storage and to halt further writing the data blocks to the read-ahead buffer.
